(19) United States
(12) Patent Application Publication
(10) Pub. No.: US 2023/0328118 A1
(43) Pub. Date: Oct. 12, 2023

(54) STREAMING HOST CONTENT ADJUSTMENT BASED ON USER INTERACTION RESPONSE DATA

(71) Applicant: Richard Wayne Pickett, JR., Brentwood, TN (US)

(72) Inventor: Richard Wayne Pickett, JR., Brentwood, TN (US)

(21) Appl. No.: 18/298,889

(22) Filed: Apr. 11, 2023

Related U.S. Application Data
(60) Provisional application No. 63/329,810, filed on Apr. 11, 2022.

(51) Int. Cl. H04L 65/1089; H04L 65/402; G06F 3/0481; G06F 40/186

(52) U.S. Cl. CPC H04L 65/1089; H04L 65/402; G06F 3/0481; G06F 40/186

(57) ABSTRACT

Systems and methods for dynamically adjusting presentation content based on user responses are described. Embodiments are configured to provide presentation content to a user from a host device, provide an interactive element in conjunction with the presentation content, collect response data from the user via the interactive element; and generate a customized document for the user based on the response data. Embodiments are further configured to provide the presentation content to a user through a website, and to customize the website based on the response data.

### CROSS-REFERENCE TO RELATED APPLICATION

This U.S. non-provisional application claims priority under 35 U.S.C. § 119 to U.S. Provisional Patent Application No. 63/329,810, filed on Apr. 11, 2022, in the United States Patent and Trademark Office, the disclosure of which is incorporated by reference herein in its entirety.

### BACKGROUND

The following relates generally to computer software, and more specifically to dynamic adjustment of streamed content.

Businesses, organizations, and solo ventures often use streaming platforms to present content and engage with audiences. These platforms can deliver livestreamed content, prerecorded videos, slide decks, and other media. Many live streaming platforms, such as YouTube and Facebook, include a live chat feature where viewers can post comments while the livestream is happening. The person or company hosting the livestream (the “host”) can read those comments as the comments are made, and reply to the comments either in the chat or through their livestream content. Additionally, some platforms enable viewers to interact with the host through voting systems.

However, the available platforms are limited in their interactivity. For example, existing systems do not provide means for a host to ask the audience specific questions, and subsequently save the responses. Livestream chat is often too much information for the host to sort through, and no practical way to collect the chat information and provide direct, customized responses to their viewers after the livestream is completed.

### SUMMARY

The present disclosure provides a systems and methods for interacting with users during a presentation, and adjusting presented content based on the interactions. Embodiments include an apparatus referred to herein as a “host device” that is configured to present an interactive element, collect user responses based on their input to the interactive element, and automatically create customized documents or adjust presented content based on the user responses. Some embodiments are further configured to customize a website for the user, prepare downloadable custom resources for the user, and present custom videos for the user.

A method, apparatus, non-transitory computer readable medium, and system for dynamic adjustment of streamed content are described. One or more aspects of the method, apparatus, non-transitory computer readable medium, and system include providing, from a host device, presentation content to a user, wherein the presentation content relates to a topic; providing an interactive element in conjunction with the presentation content; collecting response data from the user via the interactive element; and generating a customized document for the user based on the response data.

A method, apparatus, non-transitory computer readable medium, and system for dynamic adjustment of streamed content are described. One or more aspects of the method, apparatus, non-transitory computer readable medium, and system include providing, from a host device, presentation content to a user via a website, wherein the presentation content relates to a topic; providing an interactive element in conjunction with the presentation content; collecting response data from the user via the interactive element; and customizing the website based on the response data.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 shows an example of a dynamic content presentation system according to aspects of the present disclosure.

FIG. 2 shows an example of a presentation platform according to aspects of the present disclosure.

FIG. 3 shows an example of a presentation platform with prerecorded content according to aspects of the present disclosure.

FIG. 4 shows an example of an interface to the data collection component according to aspects of the present disclosure.

FIG. 5 shows a first example of a presentation content flow according to aspects of the present disclosure.

FIG. 6 shows a second example of a presentation content flow according to aspects of the present disclosure.

FIG. 7 shows an example of a method for generating a customized document according to aspects of the present disclosure.

FIG. 8 shows an example of a method for adjusting streamed presentation content according to aspects of the present disclosure.

FIG. 9 shows an example of a host control interface according to aspects of the present disclosure.

Repeat use of reference characters in the present specification and drawings is intended to represent the same or analogous features or elements of the present disclosure

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

A host can provide presentation content to users through a streaming platform. The presentation content can include targeted media, such as advertisements or informational content related to a product. In some cases, the targeted media is included as part of a customer journey. In such cases, the host may wish to customize the customer journey for each user by changing the presentation content in response to a user's data as collected during the presentation.

Embodiments are configured to provide presentation content as either livestreamed or prerecorded content. Livestreaming is a type of streaming that allows users to watch events as they happen in real-time. Livestreaming has become increasingly popular in recent years, particularly for sporting events, concerts, and other live performances. Many social media platforms, such as Facebook, Instagram, and YouTube, also offer livestreaming capabilities, allowing users to broadcast themselves live to their followers.

Prerecorded content may be recorded or rendered in advance. In many cases, prerecorded content is streamed according to a preset timeline or schedule. Embodiments herein, by contrast, are configured to provide presentation content that is customized to a user. The presentation content may include a plurality of different prerecorded or livestreamed media, as well as non-video content.

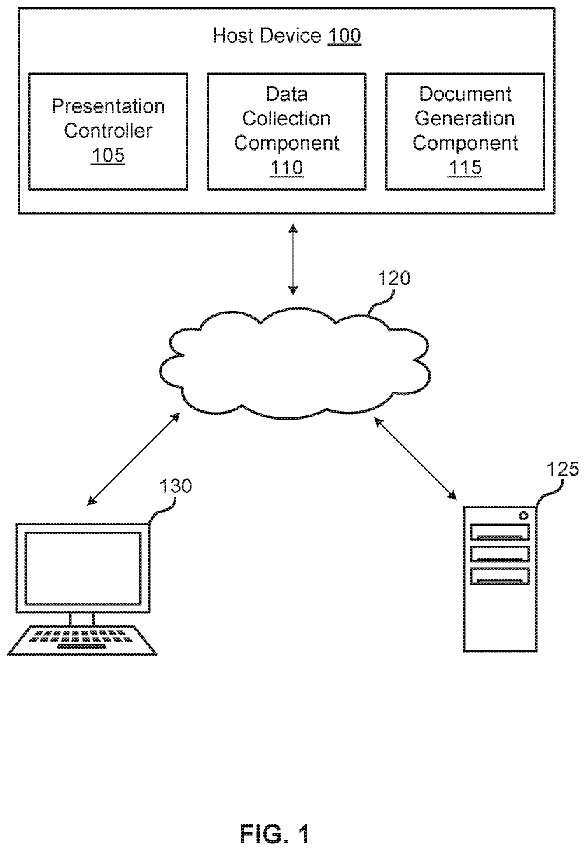

FIG. 1 shows an example of a dynamic content presentation system according to aspects of the present disclosure. The example shown includes host device 100, network 120, server 125, and user device 130. In one aspect, host device 100 includes presentation controller 105, data collection component 110, and document generation component 115.

Embodiments of host device 100 include a plurality of components. The term ‘component’ is used to partition the functionality enabled by the processors and the executable instructions included in host device 100. The partitions may be implemented physically, such as through the use of separate circuits or processors for each component, or may be implemented logically via the architecture of the code executable by the processors.

Embodiments of host device 100 include a general purpose computing device including one or more processors and a memory. In an example operation, host device 100 streams live or prerecorded content through network 120 to user device 130. In some cases, host device 100 manages content stored on, for example, server 125. The host device 100 may select content from server 125 to be streamed to user device 130 using presentation controller 105. During a presentation, data collection component 110 displays an interactive element that is overlayed on or adjacent to the presentation content. A user using user device 130 may input a response to the interactive element. Data collection component 110 then records the user response, if any to a memory of host device 100. Embodiments of host device 100 and of user device 130 may include, without limitation, a personal device such as a laptop, computer, mobile phone, tablet, or other device with network capabilities.

In some examples, presentation controller 105 reads one or more user responses from the memory of host device 100, and dynamically changes the presentation content being streamed to the user. In some examples, document generation component 115 generates a document containing the user responses. In some cases, document generation component 115 generates a document that includes information from the responses of a plurality of users. In some cases, document generation component 115 generates documents that are customized to a single user.

Embodiments of server 125 store prerecorded presentation content as well as facilitate the transmission of live content. A server such as server 125 provides one or more functions to users linked by way of one or more of the various networks such as network 120. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. The present embodiments are not limited to these protocols, and may be adapted to data exchange protocols that are developed in the future. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Server 125 may also have access to one or more databases. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with database controller. In other cases, database controller may operate automatically without user interaction.

Network 120 facilitates the transfer of information between host device 100, server 125, and user device 130. Network 120 is sometimes referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

According to some aspects, host device 100 provides, from a host device 100, presentation content to a user via a website, where the presentation content relates to a topic. In some examples, host device 100 provides a customized website based on user responses collected by data collection component 110.

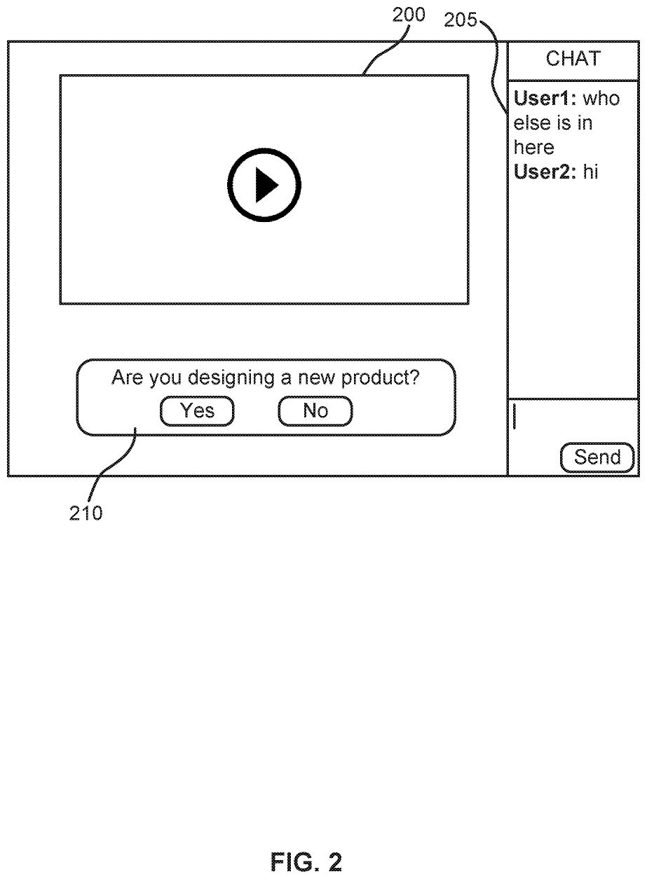

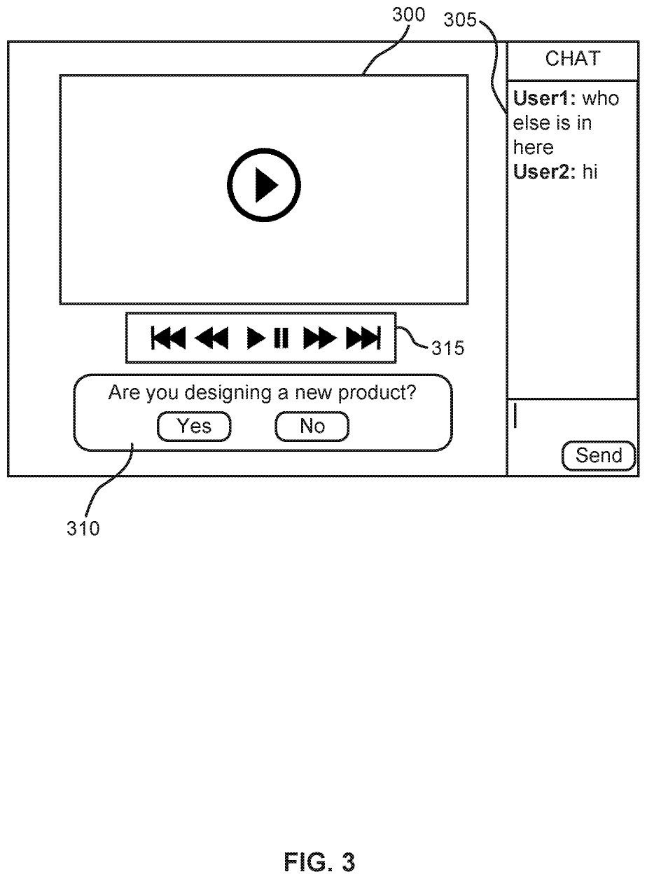

As described above, the presentation content may be livestreamed video or a prerecorded streaming video. “Presentation content” as used herein may refer to compilations of videos or media (e.g., each video individually and collectively is presentation content). The presentation content is configured to be displayed on a platform associated with the one or more servers 125, such as, for example, a website or a mobile application. The presentation content itself may be distributed from the one or more servers 125 to the platform or the presentation content may be distributed using broader content distribution networks. In various examples, the platform on which the presentation content is displayed may include features such as, for example, group chat or private messaging with other viewers or administrators (see FIG. 2). Where the presentation content is prerecorded playback control elements may be provided to allow a viewing user to pause, rewind, fast forward, or otherwise adjust the playback of the presentation content from the respective viewing user device (see FIG. 3).

According to some aspects, presentation controller 105 identifies a first livestream, and the presentation content is based on the first livestream. In some examples, presentation controller 105 identifies a second livestream occurring simultaneously with the first livestream, and provides the second livestream to the user based on the response data.

In some aspects, the presentation content includes streaming a first video, and where the presentation content further includes redirecting the user to a second video based on the response data. In some aspects, the presentation content includes streaming a first video, and where the presentation content further includes the user selectively controlling playback of the first video.

In some examples, presentation controller 105 identifies, based on the response data, secondary presentation content. In some examples, presentation controller 105 presents the secondary presentation content to the user. In some aspects, the secondary presentation content is non-video media.

In some examples, presentation controller 105 initiates a first user session, where the response data is collected during the first user session. In some examples, presentation controller 105 initiates a second user session, and displays customized content to the user during the second user session.

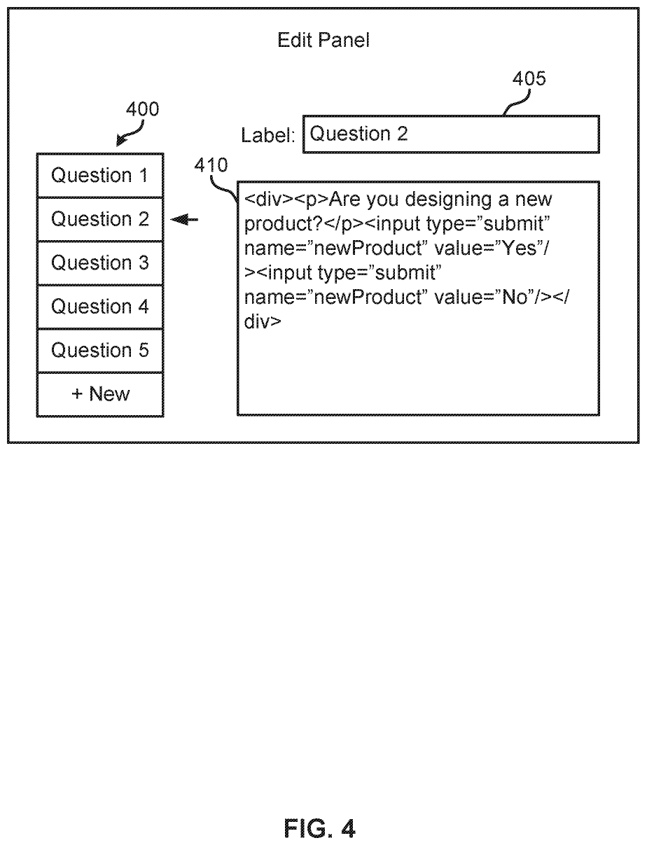

In some aspects, the interactive element is displayed by data collection component 110 at a selected playback time stamp of the presentation content. The time stamp may be configured in, for example, a code implementation window such as the one illustrated with reference to FIG. 4. When the presentation content is a prerecorded video, the system may pause the playback of the prerecorded video until a viewing user has interacted with the interactive element.

In some aspects, the interactive element is displayed in response to input from a host user. For example, when the presentation content is a live video, the host may choose to selectively display one or more interactive elements in conjunction with the live video. The host may monitor some or all of the presented content and direct the data collection component 110 to display the interactive element.

Data collection component 110 controls the timing, placement, and content of the interactive elements displayed in conjunction with the presentation content. In some examples, data collection component 110 collects identification data from a set of users. In some examples, data collection component 110 aggregates the response data and the identification data to create a database entry for each user of the set of users. The identification data may be considered a subset of the response data, and may be collected through users' responses to the interactive elements. However, the present disclosure is not limited thereto, and the identification data may be included by other means, such as a user's profile data associated with a streaming platform, website, or the like.

Once the response data has been collected, it may be compiled into a dataset and/or database. Any number of customizations can be performed during and after data has been captured. These customizations include, but are not limited to, displaying the data on any form of media, from website pages, to pdfs and documents, to graphics and videos, to sending specific emails and the content of those emails, to providing insights used for follow up, like, but not limited to, phone or text. In various examples, a data module may be configured to receive the responses as a dataset or prior to compilation of the dataset. The data module may be configured to create graphic displays of the responses and/or dataset, analyze the data, and/or associate the data with the viewing user. The graphic displays may be generated to be displayed in any media form. Where the data is associated with a viewing user, the system may further associate the data with specific email topics, insights, and/or follow up topics.

For example, generation component 115 is configured to generate a customized document for the user based on the response data. In some examples, document generation component 115 identifies a document template related to a topic included in the presentation content. In some examples, document generation component 115 removes content from a document template based on the response data to obtain the customized document. In at least one example, the customized document is referenced by presentation controller 105 to adjust the presentation content.

FIG. 2 shows an example of a presentation platform according to aspects of the present disclosure. The example shown includes presentation content 200, chat window 205, and interactive element 210. Presentation content 200, chat window 205, and interactive element 210 are examples of, or include aspects of, the corresponding elements described with reference to FIG. 3.

In the example shown, presentation content 200 includes livestreamed content. Chat window 205 includes chat conversations from one or more users. During the presentation, a data collection component such as the one described with reference to FIG. 1 displays interactive element 210 in conjunction with presentation content 200. A user may then select an option from or otherwise interact with interactive element 210. Interactive element 210 can include any inform of interactive medium, such as check boxes, buttons, drop-down selection boxes, and single-line and multi-line inputs. The data collection component then logs the response.

In at least one example, a presentation controller such as the one described with reference to FIG. 1 adjusts presentation content 200 based on the user response. For example, the presentation controller may switch from a current first livestream to a second livestream, or from the first livestream to a second stream of prerecorded content. In this way, the system provides a customized presentation to each user.

FIG. 3 shows an example of a presentation platform with prerecorded content according to aspects of the present disclosure. The example shown includes presentation content 300, chat window 305, interactive element 310, and playback control elements 315. Presentation content 300, chat window 305, and interactive element 310 are examples of, or include aspects of, the corresponding elements described with reference to FIG. 2.

In this example, presentation content 300 includes prerecorded content. A presentation controller may provide playback control elements 315 to allow the user to navigate various positions of presentation content 300. In some cases, playback control elements 315 apply to a portion or segment of presentation content 300, while other portions of presentation content 300 are only accessible by the user through their interaction with one or more interactive elements 310. As described above, in some cases, the presentation controller pauses the playback of the current presentation content 300 until the user has responded to the interactive element 310. In some cases, the presentation controller automatically sets a playback time of the presentation content 300 based on the user's response to interactive element 310. In at least one example, the presentation controller redirects the user to livestreamed presentation content based on the user's response to interactive element 310. In this example, the presentation controller may or may not remove playback control elements 315.

FIG. 4 shows an example of an interface to the data collection component according to aspects of the present disclosure. The example shown includes list of questions 400, question label 405, and question code implementation 410.

FIG. 4 shows an “edit panel” as part of a graphical user interface (GUI) of the data collection component that allows a host to edit a current list of interactive elements. In some examples, the interactive elements include the list of questions 400. Each question in the list of questions may include its own question label 405 and question code implementation 410, which are both editable by the host.

In at least one embodiment, the “edit panel” allows the host to inject logic into questions within the list of questions 400. In this way, the host enables the data collection component to automatically control the presentation controller. Accordingly, the presentation controller may dynamically adjust the presentation content based on predetermined logic as well as real-time decisions from the host.

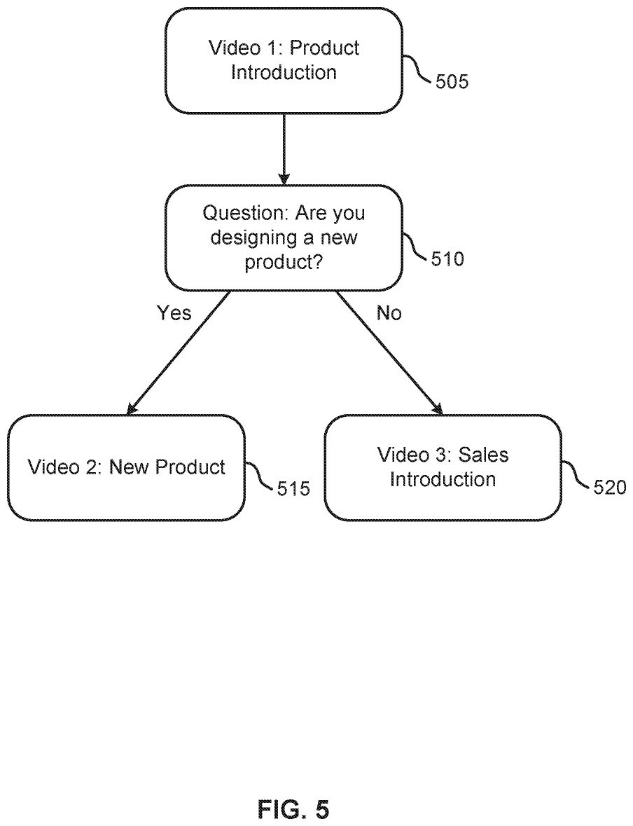

FIG. 5 shows a first example 500 of a presentation content flow according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system provides a first presentation content “Video 1: Product Introduction.” The first presentation content may be applicable to all users of the current session. In this example, the presentation content may be a prerecorded video.

At operation 510, the system presents an interactive element to the user which contains a question. In this example, the question is “Are you designing a new product?” The inputs for this interactive element include “yes” and “no.”

If the user selects “yes”, the system proceeds to operation 515, and presents a second presentation content “Video 2: New Product.” This content, for example, may be a video that is related to designing new products.

If the user selects “no”, the system proceeds to operation 520, and presents a third presentation content “Video 3: Sales Introduction.” In this case, the second presentation content may not stream to the users who selected “no”. Instead, the system redirects the user to the third presentation content. The third presentation content may be a video that relates to the sale of an existing product, for example.

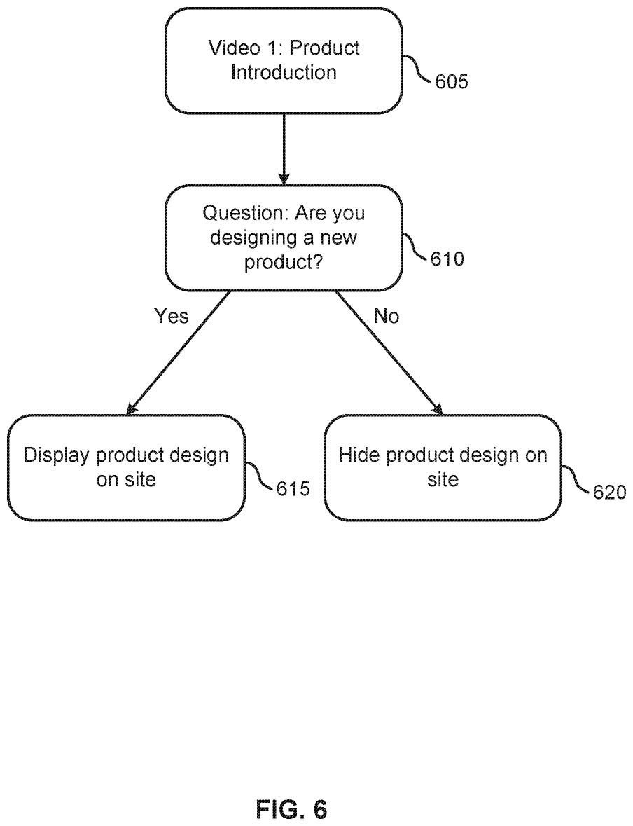

FIG. 6 shows a second example 600 of a presentation content flow according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

FIG. 6 describes a similar process as FIG. 5, except in that FIG. 6 further includes a customized experience for the user in a second session. For example, FIG. 6 may apply to a user's subsequent visit to a web site after a presentation session including the streamed content.

At operation 605, the system provides a first presentation content “Video 1: Product Introduction.” At operation 610, the system presents an interactive element to the user which contains a question, such as “Are you designing a new product?” Based on the user's input to the interactive element, the system may provide customized presentation content similar to the process described with reference to FIG. 5.

If the user has previously answered yes at operation 610, then, in operation 615, the system displays a product design on a website. Operation 615 may be executed in a subsequent session, such as a session that occurs after a presentation streaming session.

If the user has previously answered no at operation 610, then, in operation 620, the system hides the product design on the website. In this way, the system provides a customized experience for the user during both streamed presentation content and other presentation content, such as content displayed on a website.

FIGS. 5 and 6 provide simple examples of dynamically changing presentation content based on user responses to interactive elements. However, the system is not limited to these paths. For example, embodiments of the system are configured to direct the user through many different paths based on their responses, including cyclic paths, paths with several sub-branches, and the like. In some embodiments, the system creates a customized profile for each user including information from all of their past responses, and automatically adjusts the presentation content based on this customized profile.

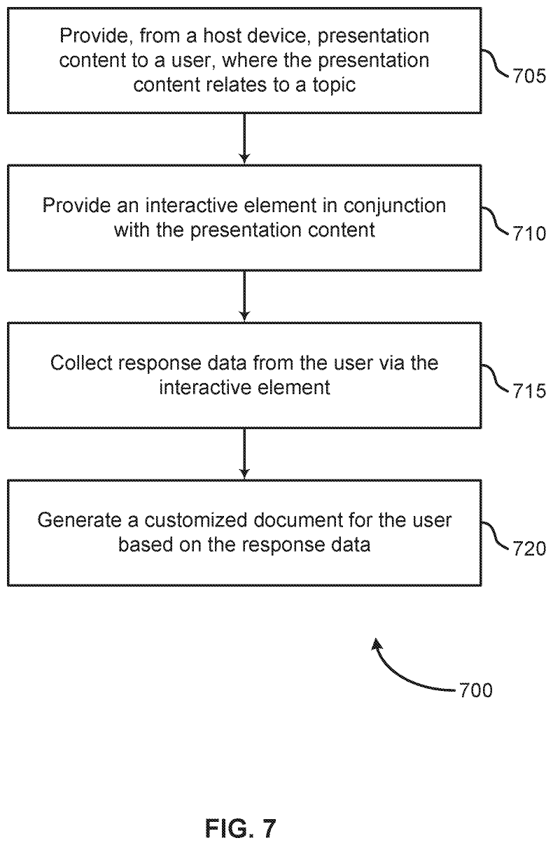

FIG. 7 shows an example of a method 700 for generating a customized document according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system provides, from a host device, presentation content to a user, where the presentation content relates to a topic. In some cases, the operations of this step refer to, or may be performed by, a presentation controller of a host device as described with reference to FIG. 1. The presentation content may initially be the same for all users, such as in the examples described with reference to FIGS. 5-6.

At operation 710, the system provides an interactive element in conjunction with the presentation content. In some cases, the operations of this step refer to, or may be performed by, a data collection component of the host device as described with reference to FIG. 1. The interactive element may include a question with various options for input. For example, a user may input one of a plurality of choices, or may enter a text response.

At operation 715, the system collects response data from the user via the interactive element. In some cases, the operations of this step refer to, or may be performed by, the data collection component as described with reference to FIG. 1. The response data may include a plurality of different response types, and may be stored as a body of composite data.

At operation 720, the system generates a customized document for the user based on the response data. In some cases, the operations of this step refer to, or may be performed by, a document generation component as described with reference to FIG. 1. In some aspects, the system identifies a document template, and then edits or removes items from the document template to generate the customized document. In at least one embodiment, the customized document includes a representation of the user's response data from one or more sessions.

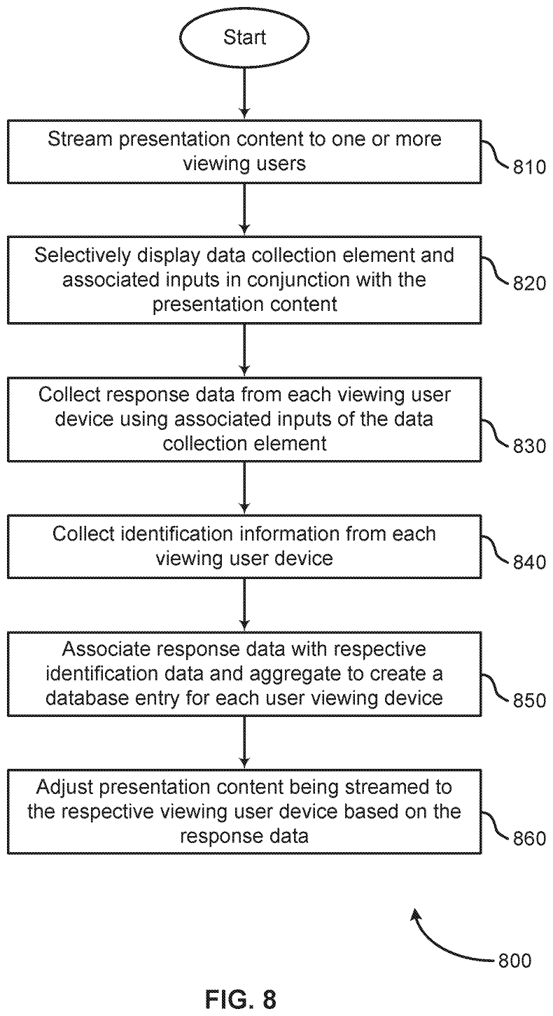

FIG. 8 shows an example of a method for adjusting streamed presentation content according to aspects of the present disclosure. The method includes a series of steps. In some examples, these steps are performed by a system including a processor executing a set of codes to control functional elements of an apparatus. Additionally or alternatively, certain processes are performed using special-purpose hardware. Generally, these steps are performed according to the methods and processes described in accordance with aspects of the present disclosure. In some cases, the steps described herein are composed of various substeps, or are performed in conjunction with other operations.

The method includes step 810 of streaming presentation content to one or more viewing user devices. Another step 820 includes selectively displaying a data collection element and one or more associated inputs in conjunction with the presentation content. The method 200 further may include collecting response data from each viewing user device using the associated inputs of the data collection element (step 830) and collecting identification data from each viewing user device (step 840). Another step 850 may include associating the response data with the identification data for each viewing user device and/or aggregating the response data and the identification data to create a database entry for each viewing user device. The method 800 further includes a step of adjusting, based on the response data of each viewing user device, the presentation content being streamed to the respective viewing user device. This allows a presentation user to adjust the streaming of presentation content to a viewing user based on response data from the viewing user provided through inputs of the data collection element.

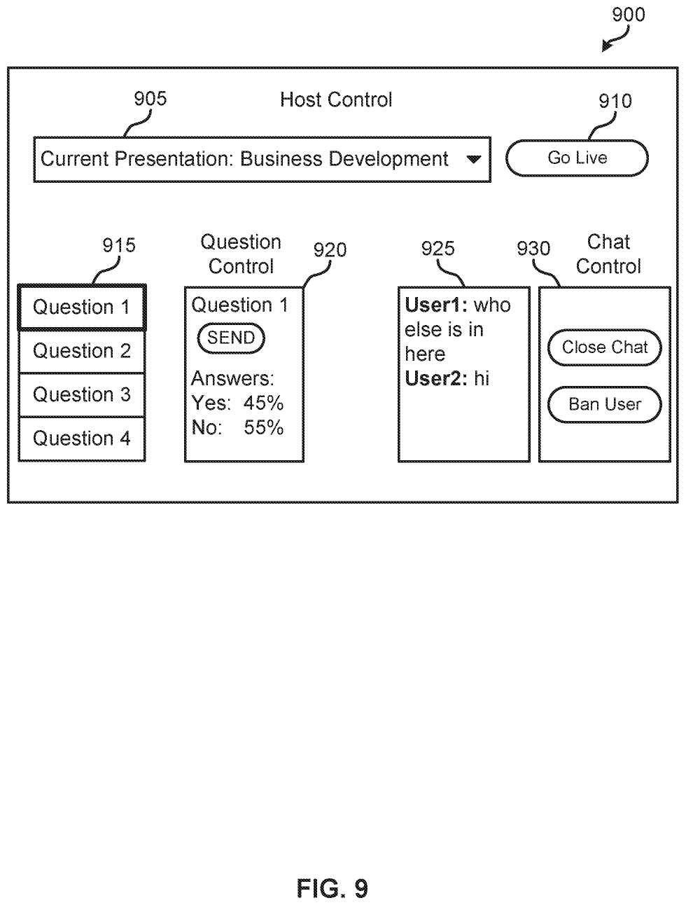

FIG. 9 shows an example of a host control interface according to aspects of the present disclosure. The example shown includes host control interface 900, presentation selector 905, live toggle 910, interactive element list 915, interactive element control 920, chat view 925, and chat control 930.

FIG. 9 shows a host control interface 900 as part of a GUI available to a host operating the dynamic content presentation system according to aspects of the present disclosure. The host control interface 900 includes controls that are configurable to operate a presentation controller and a data collection component as described with reference to FIG. 1. An example set of controls available to a host will now be described. This set is provided as an example, however, is not an exhaustive list. For instance, the controls shown in FIG. 9 may correspond to a set of controls available to a host in a first session, and other controls may be available to the host in different sessions.

Presentation selector 905 includes a drop-down list of available presentations. According to some aspects, the available presentations may include a combination of channels including pre-recorded content, livestream content, and non-video content.

Live toggle 910 allows the host to present the content to one or more users if the host is not already doing so. Live toggle 910 may update its text based on the status of the presentation. For example, if content is currently streaming to the users, the text may update from “Go Live” to “End Presentation”, and live toggle 910 would then enable the host to cease the presentation.

Interactive element list 915 includes a list of all available interactive elements corresponding to the current presentation. In some examples, the elements included in interactive element list 915 are pre-configured using the interface described with reference to FIG. 4. Selecting an element from interactive element list 915 updates the controls and metrics displayed in interactive element control 920.

Interactive element control 920 includes controls related to the selected interactive element. Interactive element control 920 may display the current or past results of the selected interactive element, and may also provide controls for the host to display the selected interactive element.

Chat view 925 provides the host with a view of the chat, if any, occurring during the presentation of content. Chat control 930 provides the host with various controls for the chat, such as turning the chat off, or selecting a user and banning them from the chat.

Accordingly, the present disclosure includes the following aspects.

A method for dynamic adjustment of streamed content is described. One or more aspects of the method include providing, from a host device, presentation content to a user, wherein the presentation content relates to a topic; providing an interactive element in conjunction with the presentation content; collecting response data from the user via the interactive element; and generating a customized document for the user based on the response data.

Some examples of the method, apparatus, non-transitory computer readable medium, and system further include identifying a first livestream, wherein the presentation content is based on the first livestream. Some examples further include identifying a second livestream occurring simultaneously with the first livestream. Some examples further include providing the second livestream to the user based on the response data.

In some aspects, the interactive element is displayed at a selected playback time stamp of the presentation content. In some aspects, the interactive element is displayed in response to input from a host user.

In some aspects, the presentation content comprises streaming a first video, and wherein the presentation content further comprises redirecting the user to a second video based on the response data. In some aspects, the presentation content comprises streaming a first video, and wherein the presentation content further comprises the user selectively controlling playback of the first video.

Some examples of the method, apparatus, non-transitory computer readable medium, and system further include identifying, based on the response data, secondary presentation content. Some examples further include presenting the secondary presentation content to the user. In some aspects, the secondary presentation content is non-video media.

Some examples of the method, apparatus, non-transitory computer readable medium, and system further include collecting identification data from a plurality of users. Some examples further include aggregating the response data and the identification data to create a database entry for each user of the plurality of users.

Some examples of the method, apparatus, non-transitory computer readable medium, and system further include identifying a document template related to the topic. Some examples further include removing content from the document template based on the response data to obtain the customized document.

A method for dynamic adjustment of streamed content is described. One or more aspects of the method include providing, from a host device, presentation content to a user via a website, wherein the presentation content relates to a topic; providing an interactive element in conjunction with the presentation content; collecting response data from the user via the interactive element; and customizing the website based on the response data.

Some examples of the method, apparatus, non-transitory computer readable medium, and system further include initiating a first user session, wherein the response data is collected during the first user session. Some examples further include initiating a second user session. Some examples further include providing the customized website during the second user session.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Currently, videos are used primarily as one-way communication. Direct interaction with the viewers, collecting information and customizing their experience isn't used. This system and method provides for that collection and customization. Additional exemplary areas of use may be employee interviews and induction, online testing with grades and follow-up study based on the answers given, self-assessments with customized results, and market segmentation at scale.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims. For example, aspects of the present disclosure may be implemented in hardware or software or in a combination of hardware and software. The embodiments of the disclosure herein may be implemented as a program product for use with a computer system and having programs which define functions of the disclosure (including the methods described herein) and may be contained on a variety of computer-readable storage media, including by way of example, non-writable storage media on which information is permanently stored and writable storage media on which alterable information is stored. When carrying computer-readable instructions that direct the functions of the present disclosure, such computer-readable storage media is considered an embodiment of the present disclosure.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
providing, from a host device, presentation content to a user, wherein the presentation content relates to a topic;
providing an interactive element in conjunction with the presentation content;
collecting response data from the user via the interactive element; and
generating a customized document for the user based on the response data.

2. The method of claim 1, further comprising:
providing the presentation content comprises streaming the presentation content from the host device.

3. The method of claim 2, wherein:
the streaming comprises livestreaming.

4. The method of claim 3, further comprising:
identifying a first livestream, wherein the presentation content is based on the first livestream;
identifying a second livestream occurring simultaneously with the first livestream; and
providing the second livestream to the user based on the response data.

5. The method of claim 1, wherein:
the interactive element is displayed at a selected playback time stamp of the presentation content.

6. The method of claim 1, wherein:
the interactive element is displayed in response to input from a host user.

7. The method of claim 1, wherein:
the presentation content comprises streaming a first video, and wherein the presentation content further comprises redirecting the user to a second video based on the response data.

8. The method of claim 1, wherein:
the presentation content comprises streaming a first video, and wherein the presentation content further comprises the user selectively controlling playback of the first video.

9. The method of claim 1, further comprising:
identifying, based on the response data, secondary presentation content; and
presenting the secondary presentation content to the user.

10. The method of claim 9, wherein:
the secondary presentation content is non-video media.

11. The method of claim 1, further comprising:
collecting identification data from a plurality of users; and
aggregating the response data and the identification data to create a database entry for each user of the plurality of users.

12. The method of claim 1, further comprising:
identifying a document template related to the topic; and
removing content from the document template based on the response data to obtain the customized document.

13. A method comprising:
providing, from a host device, presentation content to a user via a website, wherein the presentation content relates to a topic;
providing an interactive element in conjunction with the presentation content;
collecting response data from the user via the interactive element; and
customizing the website based on the response data.

14. The method of claim 13, further comprising:
initiating a first user session, wherein the response data is collected during the first user session;
initiating a second user session; and
providing the customized website during the second user session.

15. A non-transitory computer readable medium storing code, the code comprising instructions executable by a processor to:
provide, from a host device, presentation content to a user via a website, wherein the presentation content relates to a topic;
provide an interactive element in conjunction with the presentation content;
collect response data from the user via the interactive element; and
customize the website based on the response data.

16. The non-transitory computer readable medium of claim 15, the code further comprising instructions executable by the processor to:
initiate a first user session, wherein the response data is collected during the first user session;
initiate a second user session; and
provide the customized website during the second user session.
